(19) United States
(12) Patent Application Publication
(10) Pub. No.: US 2011/0201738 A1
(43) Pub. Date: Aug. 18, 2011

(54) Polyolefin Nanocomposites

(76) Inventor: Robert L. Sherman, JR., Blue Ash, OH (US)

(21) Appl. No.: 12/658,886

(22) Filed: Feb. 17, 2010

(51) Int. Cl. C08K 3/34; C08K 3/32; C08K 5/13

(52) U.S. Cl. 524/323; 524/443; 524/417; 524/414

(57) ABSTRACT

Disclosed is a polyolefin nanocomposite. The nanocomposite comprises a polyolefin, a quaternary ammonium modified nanoclay, and a Bronsted acid. The polyolefin nanocomposite can have reduced color compared with those which contain polyolefin and quaternary ammonium modified clay but does not contain Bronsted acid. It is useful for making films, pipes, geomembranes, containers, automotive parts, and wire and cable insulations and jackets.

### FIELD OF THE INVENTION

The present invention relates to polyolefin nanocomposites. More particularly, the invention relates to polyolefin nanocomposites that have reduced color.

### BACKGROUND OF THE INVENTION

Polymer-clay nanocomposites are known. They are materials comprising a polymer matrix and exfoliated clay that is dispersed in the polymer matrix. Nanocomposites have improved mechanical properties and heat resistance compared with the base polymer. Moreover, due to the layered structures, nanocomposites have increased barrier properties. This characteristic makes nanocomposites desirable candidates for packaging materials. Thus, there is an increasing interest in developing polyolefin-clay nanocomposites since polyolefins are the most widely used packaging materials.

Clays are hydrophilic. Thus, to prepare polymer-clay composites, clays are treated with organic compounds to convert them into organoclays. Organoclays have improved compatibility with polymers. When an organoclay is dispersed in a polymer matrix, the polymer chains insert between the adjacent layers and thereby the clay is delaminated. This process is called exfoliation.

One problem associated with the use of quaternary ammonium modified clay is that it causes color in polyolefin nanocomposites. New polyolefin nanocomposites are needed. Ideally the nanocomposites employ commonly used quaternary ammonium modified clay but have low color.

### SUMMARY OF THE INVENTION

The invention is a polyolefin nanocomposite. The nanocomposite comprises a polyolefin, a quaternary ammonium modified nanoclay, and a Bronsted acid. The nanocomposite preferably has reduced color compared with nanocpmposites which contain the polyolefin and quaternary ammonium modified nanoclay but do not contain the Bronsted acid.

### DETAILED DESCRIPTION OF THE INVENTION

Suitable polyolefins for use in the nanocomposite of the invention include those made from one or more C₂-C₁₀ α-olefin monomers. Preferably, the polyolefin is selected from the group consisting of polyethylene, polypropylene, polybutene, the like, and mixtures thereof. Suitable polyethylene includes ethylene homopolymers, copolymers of ethylene with at least one C₃ to C₁₀ α-olefin, the like, and mixtures thereof. They include high-density polyethylene (HDPE, density 0.941 g/cm³ or greater), low-density polyethylene (LDPE, density 0.910 g/cm³ to 0.925 g/cm³), medium-density polyethylene (MDPE, density 0.926 g/cm³ to 0.940 g/cm³), and linear low-density polyethylene (LLDPE, density 0.910 g/cm³ to 0.925 g/cm³), ultra-low density polyethylene or polyethylene plastomers (density less than 0.910 g/cm³), the like, and mixtures thereof. Suitable polyethylene has a melt index (MI₂) (as determined by ASTM D-1238-01 at a temperature of 190° C. and at a load of 2.16 kg) preferably within the range of 0.01 dg/min to 150 dg/min, more preferably within the range of 0.01 dg/min to 10 dg/min, and most preferably within the range of 0.01 dg/min to 5 dg/min.

Suitable polypropylene includes amorphous polypropylene, semi-crystalline polypropylene, the like, and mixtures thereof. Preferably, the semi-crystalline polypropylene is selected from the group consisting of propylene homopolymers, copolymers of propylene with at least one other C₂ to C₁₀ α-olefin, the like, and mixtures thereof. Copolymers of propylene include random copolymers and impact copolymers. Preferred α-olefins for such copolymers include ethylene, 1-butene, 1-pentene, 1-hexene, methyl-1-butenes, methyl-1-pentenes, 1-octene, 1-decene, the like, and mixtures thereof. “Semi-crystalline,” as used herein, means that the crystallinity is greater than or equal to 40%, preferably greater than or equal to 55%, and more preferably greater than or equal to 80%. Preferably, the semi-crystalline polypropylene has a melt flow rate (as determined by ASTM D-1238-01 at a temperature of 230° C. and at a load of 2.16 kg) within the range of 0.001 dg/min to 500 dg/min. Preferably, the semi-crystalline polypropylene has a density within the range of 0.897 g/cm³ to 0.925 g/cm³ and a weight average molecular weight (Mw) within the range of 85,000 to 900,000.

Suitable polybutene includes homopolymers of butene-1, copolymers of butene-1 with at least one other C₂ to C₁₀ α-olefin, the like, and mixtures thereof. Preferred α-olefins for such copolymers include ethylene, propylene, 1-pentene, 1-hexene, methyl-1-butenes, methyl-1-pentenes, 1-octene, 1-decene, the like, and mixtures thereof. The polybutene has a melt index (as determined by ASTM D-1238, Condition E) preferably within the range of 0.01 dg/min to 1000 dg/min, more preferably within the range of 0.1 dg/min to 750 dg/min. Methods for producing polybutene are known. For instance, see U.S. Pat. No. 6,306,996, the teachings of which are herein incorporated by reference.

Polyethylene is a preferred polyolefin for use in the nanocomposite of the invention. HDPE is more preferred. Suitable HDPE preferably has a density within the range of 0.94 g/cm³ to 0.965 g/cm³. Suitable HDPE can be made by Ziegler-Natta, single-site, or any other catalysts.

Suitable quaternary ammonium modified clay includes montmorillonite, saponite, hectorite, mica, vermiculite, bentonite, nontronite, beidellite, volkonskoite, magadite, and kenyaite, the like, and mixtures thereof. The modified clay is often called organoclay or nanoclay. They are commercially available, for example, from Southern Clay Products, Inc. Preferably quaternary ammonium modified nanoclay is present in the nanocomposite in an amount within the range of 0.05 wt % to 65 wt %, more preferably within the range of 0.5 wt % to 25 wt %, and most preferably within the range of 0.5 wt % to 5 wt %.

Suitable Bronsted acids include organic and inorganic Bronsted acids. Examples of suitable Bronsted acids include phosphoric acid, phosphorous acid, polyphosphoric acid, stearic acid, benzoic acid, lactic acid, p-toluenesulfonic acid, the like, and mixtures thereof. Preferably the Bronsted acid is an inorganic Bronsted acid. Preferably, the inorganic Bronsted acid is selected from the group consisting of phosphoric acid, phosphorous acid, and polyphosphoric acid. Preferably, the Bronsted acids have a boiling point greater than the melting point of the polyolefin, and thus the acids do not evaporate during the thermal processing of the nanocomposite. Preferably, the Bronsted acid does not decompose during the thermal processing of the nanocomposite. Preferably, the Bronsted acid is present in an amount sufficient to reduce or eliminate the color induced by the use of quaternary ammonium modified nanoclay. Preferably, the Bronsted acid is present in an amount within the range of 0.005 wt % to 1 wt %, more preferably within the range of 0.05 wt % to 0.5 wt %, and most preferably within the range of 0.1 wt % to 0.3 wt %, of the nanocomposite.

The nanocomposite of the invention optionally comprises an antioxidant. Suitable antioxidants include primary and secondary antioxidants known to the polyolefin industry. Suitable primary antioxidants include hindered phenols and secondary aromatic amines. These primary antioxidants terminate free radicals by transferring hydrogen from the OH or NH groups to the free radical. The resulting phenoxy and amino radicals are stable and thus do not abstract hydrogen from the polyolefin. Secondary antioxidants decompose hydroperoxides into non-radical, thermally stable products. Suitable secondary antioxidants include phosphite and thio compounds. Preferably, the antioxidant is a combination of primary and secondary antioxidants. Preferably, the primary antioxidant is a phenolic antioxidant. An example of suitable phenolic antioxidants is pentaerythrityl tetrakis(3-(3,5-di-tert-butyl-4-hydroxyphenol)propionate), which is commercially available from Ciba Inc. under the name of IRGANOX® 1010. Suitable amounts of antioxidants in the nanocomposite of the invention are preferably within the range of 0.005 wt % to 5 wt %, more preferably within the range of 0.01 wt % to 1 wt %, and most preferably within the range of 0.05 wt % to 0.5 wt %, of the nanocomposite.

The nanocomposite of the invention optionally comprises a maleated polyolefin. Maleated polyolefins are used as compatiblizing agents between the nanoclay and the polyolefin. Suitable maleated polyolefin for use in the invention include maleated HDPE, LDPE, LLDPE, propylene homopolymers, propylene random copolymers, propylene impact copolymers, the like, and mixtures thereof. Methods for maleating polyolefin are known. For instance, U.S. Pat. No. 6,716,928, the teachings of which are incorporated herein by reference, teaches maleating a propylene impact copolymer. Preferably, the maleated polyolefin is a maleated HDPE. Suitable HDPE for making maleated HDPE includes ethylene homopolymers and copolymers of ethylene and one or more C₃ to C₁₀ α-olefins. Suitable α-olefins include 1-butene, 1-hexene, and 1-octene, the like, and mixtures thereof. Preferably, the HDPE comprises less than 5 wt % of the C₃ to C₁₀ α-olefins. The density of HDPE is preferably within the range of 0.932 g/cm³ to 0.965 g/cm³ and more preferably within the range 0.952 g/cm³ to 0.965 g/cm³. The maleated polyolefin preferably contains from 0.1 wt % to 10 wt %, 0.5 wt % to 5 wt %, and most preferably from 1 wt % to 2.5 wt %, of grafted maleic anhydride. The maleated polyolefin is present in the nanocomposite in an amount preferably within the range of 5 wt % to 35 wt %, more preferably within the range of 5 wt % to 25 wt %, and most preferably within the range of 8 wt % to 15 wt %.

The nanocomposite of the invention optionally comprises other additives, fillers, and modifiers. Suitable additives fillers and modifiers include foaming agents, cross-linking agents, nucleation agents, flame retardants, processing aids, antistatic agents, lubricants, optical brighteners, pigments, dispersants, water-blocking agents, UV absorbents, light stabilizers, glass fibers, the like, and mixtures thereof. Additives and fillers are used in an amount preferably within the range of 0.05 to 60 wt %, more preferably within the range of 0.05 wt % to 15 wt %, and most preferably within the range of 0.05 wt % to 5 wt %, of the nanocomposite.

The nanocomposite of the invention can be made by mixing the various components. Any suitable mixing methods known in the industry can be used, including the masterbatch methods. Melt blending is a preferred method. Melt mixing is preferably performed by extrusion. The various components can be mixed in any order.

The invention includes an article comprising the nanocomposite, including films, pipes, geomembranes, containers, automotive parts, and wire and cable insulations and jackets. The nanocomposite of the invention is particularly useful for making injection-molded articles.

The following examples merely illustrate the invention. Those skilled in the art will recognize many variations that are within the spirit of the invention and scope of the claims.

### Comparative Example 1

### Nanocomposite Containing HDPE, Quaternary Ammonium Modified Nanoclay but No Bronsted Acid

HDPE reactor powder (97.9 parts by weight, copolymer of ethylene and 1-butene, MI: 0.057 dg/min, and density 0.950 g/cm³), quaternary ammonium modified nanoclay (2.0 parts by weight, Cloisite 15A, product of Southern Clay Products Inc.) and pentaerythrityl tetrakis(3-(3,5-di-tert-butyl-4-hydroxyphenyl)propionate (0.1 parts by weight, Irganox 1010, product of Ciba Inc.) are mixed by shaking vigorously. The mixture is melt-blended in a Brabender mixer at 200° C. with 1 minute of flux time after complete melting of the materials. The blend is compression-molded according to ASTM D4703. The molded samples are analyzed for yellowness index using a Huntelab 6000 spectrophotometer according to ASTM D1925. The samples have an average yellowness index of 32.

### Example 2

### Nanocomposite Containing HDPE, Quaternary Ammonium Modified Nanoclay and Phosphoric Acid

The general procedure of Comparative Example 1 is followed but HDPE (97.8 parts by weight), Cloisite 15A (2.0 parts by weight), Irganox 1010 (0.1 part by weight), and phosphoric acid (0.1 part by weight) are mixed. The samples have an average yellowness index of 14.

### Example 3

### Nanocomposite Containing HDPE, Quaternary Ammonium Modified Nanoclay and Phosphoric Acid

The general procedure of Comparative Example 1 is followed but HDPE (97.7 parts by weight), Cloisite 15A (2.0 parts by weight), Irganox 1010 (0.1 part by weight), and phosphoric acid (0.2 part by weight) are mixed. The samples have an average yellowness index of 10.

### Comparative Example 4

### Nanocomposite Containing HDPE, Quaternary Ammonium Modified Nanoclay but No Bronsted Acid

The general procedure of Comparative Example 1 is followed but HDPE (94.9 parts by weight), Cloisite 15A (5.0 parts by weight), and Irganox 1010 (0.1 part by weight) are mixed. The samples have an average yellowness index of 53.

### Example 5

### Nanocomposite Containing HDPE, Quaternary Ammonium Modified Nanoclay and Phosphoric Acid

The general procedure of Comparative Example 4 is followed; HDPE (94.8 parts by weight), Cloisite 15A (5.0 parts by weight), Irganox 1010 (0.1 part by weight), and phosphoric acid (0.1 part by weight) are mixed. The samples have an average yellowness index of 28.

### Example 6

### Nanocomposite Containing HDPE, Quaternary Ammonium Modified Nanoclay and Phosphoric Acid

The general procedure of Comparative Example 4 is followed; HDPE (94.7 parts by weight), Cloisite 15A (5.0 parts by weight), Irganox 1010 (0.1 part by weight), and phosphoric acid (0.2 part by weight) are mixed. The samples have an average yellowness index of 26.

### Comparative Examples 7 and 8

### Nanocomposites Containing HDPE, Sodium Montmorillonite Clay with or without Bronsted Acid

The general procedure of Comparative Example 4 is followed. In Comparative Example 7, HDPE (94.9 parts by weight), Cloisite NA (5.0 parts by weight), and Irganox (0.1 part by weight) are mixed. In Comparative Example 8, HDPE (94.7 parts by weight), sodium montmorillonite clay (5.0 parts by weight, Cloisite NA, product of Southern Clay Products Inc.), Irganox 1010 (0.1 part by weight), and phosphoric acid (0.2 part by weight) are mixed. No difference in color between these two nanocomposites is observed.

TABLE 1
RESULTS SUMMARY

| Ex. | HDPE | Clay | Irganox 1010 | Phosphoric acid | Yellowness |
|---|---|---|---|---|---|
| No | % | % | % | % | Index |
| C1 | 97.9 | 2.0 | 0.1 | 0 | 32 |
| 2 | 97.8 | 2.0 | 0.1 | 0.1 | 14 |
| 3 | 97.7 | 2.0 | 0.1 | 0.2 | 10 |
| C4 | 94.9 | 5.0 | 0.1 | 0 | 53 |
| 5 | 94.8 | 5.0 | 0.1 | 0.1 | 28 |
| 6 | 94.7 | 5.0 | 0.1 | 0.2 | 26 |

I claim:

1. A polyolefin nanocomposite comprising a polyolefin, a quaternary ammonium modified nanoclay, and a Bronsted acid.

2. The nanocomposite of claim 1, wherein the polyolefin is a homopolymer or copolymer of C₂ to C₁₀ α-olefins.

3. The nanocomposite of claim 2, wherein the polyolefin is selected from the group consisting of polyethylenes, polypropylenes, polybutenes, and mixtures thereof.

4. The nanocomposite of claim 3, wherein the polyolefin is a polyethylene.

5. The nanocomposite of claim 1, wherein the Bronsted acid is an inorganic Bronsted acid.

6. The nanocomposite of claim 5, wherein the Bronsted acid is selected from the group consisting of phosphoric acid, phosphorous acid, polyphosphoric acid, and mixtures thereof.

7. The nanocomposite of claim 1, wherein the Bronsted acid is present in an amount sufficient to reduce color.

8. The nanocomposite of claim 7, wherein the Bronsted acid is present in an amount within the range of 0.05 wt % to 0.5 wt %.

9. The nanocomposite of claim 1, which comprises from 0.5 wt % to 5 wt % of the nanoclay.

10. The nanocomposite of claim 1, which further comprises an antioxidant.

11. The nanocomposite of claim 10, wherein the antioxidant is a phenolic antioxidant.

12. The nanocomposite of claim 10, wherein the antioxidant is present in an amount within the range of 0.05 wt % to 2.5 wt % of the nanocomposite.

13. The nanocomposite of claim 12, wherein the antioxidant is present in an amount within the range of 0.1 wt % to 0.5 wt %.

14. The nanocomposite of claim 1, further comprising a maleated polyolefin.

15. An article comprising the nanocomposite of claim 1.
